(19) United States
(12) Patent Application Publication
(10) Pub. No.: US 2008/0113063 A1
(43) Pub. Date: May 15, 2008

(54) MICRONUTRIENT SUPPLEMENT

(76) Inventors: Ralph E. Roper, Carmel, IN (US); Shannon R. Wilson, Indianapolis, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/559,688

(22) Filed: Nov. 14, 2006

(51) Int. Cl. A23L 1/304; A23K 1/175; C01G 3/00

(52) U.S. Cl. 426/2; 426/74; 423/43

(57) ABSTRACT

This disclosure relates to a family of micronutrient supplements that can be used in food or in animal feeds and to methods of enhancing the growth of animals using one or more of the supplements. The family of micronutrient supplements is an ammine chloride salt of an essential metal. Representative essential metals for use according to this disclosure include a divalent or trivalent cation of zinc, copper, manganese, magnesium, chrome, iron, cobalt and calcium. When provided as a metal ammine chloride salt, the essential metal is highly bioavailable to enhance the survivability, growth, health and/or reproductivity of animals. The micronutrient supplement can be administered to animals either as a single supplement or admixed with other nutrients or feeds.

### FIELD

This disclosure describes a family of micronutrient supplements and a method for their use to enhance the survivability, growth, health and/or reproductivity of humans and animals. More specifically, this disclosure is directed to a variety of metal ammine chloride micronutrient supplements that provide a high bioavailability of an essential metal to humans and animals, and to a method of enhancing their growth by administering the micronutrient supplement in a variety of ways, including, but not limited to foods and animal feeds.

### BACKGROUND

Micronutrients include vitamins and some elements usually in the form of minerals or metal salts; most notably the elements include calcium, phosphorus, potassium, iron, zinc, copper, magnesium, manganese and iodine. Micronutrients are generally consumed in small amounts, i.e., less than 1 gm/day, and are usually absorbed unchanged. Many essential elements have catalytic functions. While the micronutrients are often present in minute amounts, their bioavailability is essential for survival, growth, health and reproduction. Micronutrients are important for children and other young animals, particularly during their early development years when they are rapidly growing. Furthermore, many new animal breeds require additional amounts of micronutrients as their abilities to grow at a faster rate while consuming less feed has improved. This intensive growth imposes greater metabolic stresses, thereby causing increased susceptibility to vitamin deficiencies. It is well recognized that the needed micronutrients are often not found or not found in sufficient quantities in their food or feed sources, whether these sources are naturally occurring or commercially prepared. Consequently, virtually all industrial food and feed formulations are fortified with vitamins and minerals. The cost to commercial livestock producers for supplying micronutrients to their livestock herds can be staggering.

While human and animal requirements for additional nutrients have been well documented, the availability of the micronutrients has not always met their needs. It

A representative example of a procedure for preparing copper diammine chloride (“CDC”) and/or ammonium ammine copper chloride (“AACC”) is depicted in FIG. 2 which is useful for preparation of another preferred embodiment of the present disclosure. The method is particularly attractive for making CDC and/or AACC from spent alkaline or acidic copper etchants such as those generated from the manufacture of printed circuit boards; or from less concentrated liquors containing dissolved copper and ammonium chloride. When the starting liquid is an acidic solution of copper chloride or an acidic solution of copper chloride and ammonium chloride, CDC and/or AACC are/is precipitated by adding aqueous or anhydrous ammonia to raise the pH to from about 4.5 to about 6.5 and more preferably from about 5.0 to about 6.0, and most preferred, from about 5.0 to about 5.5. Formation of the CDC and/or AACC is preferably carried out at a temperature of from about 5° C. to about 90° C., and preferably from about 10° C. to 40° C. If an alkaline reagent other than ammonia is used for raising the pH, ammonium chloride can be added to provide a source of both ammonia and chloride.

As the pH is raised to between about 4.5 and 5.0, the equilibrium for ammonium ion (NH₄⁺) is shifted toward free ammonia (NH₃) and a green precipitant forms that is thought to be copper diammine chloride as illustrated in Equation 3 below.

CuCl₂+2NH₄OH→Cu(NH₃)₂Cl₂↓+2H₂O Equation 3

As the pH is increased higher to between about 5.0 and about 5.5, more free ammonia becomes available and the green colored copper diammine chloride salt transitions to a robin-egg blue colored salt believed to be insoluble ammonium ammine copper chloride. The chemical reaction is conjectured to be that of Equation 4:

Cu(NH₃)₂Cl₂+NH₄Cl→NH₄Cl.Cu(NH₃)₂Cl₂↓ Equation 4

is not sufficient to simply increase amounts of the micronutrients in the food or feed sources. This method can be ineffective, wasteful and unsafe. Many of the micronutrients are not readily absorbed so that the added amounts of vitamins and minerals are simply excreted. Excess loading of vitamins and minerals can be unsafe and in certain circumstances can be toxic, thereby causing severe acute or chronic harm or even death. Thus, there is a need to provide an inexpensive, readily absorbed micronutrient to decrease costs, reduce waste and help establish a more precise control of the nutritional requirement for humans and animals.

It has been well established that different levels of a variety of metals are necessary micronutrients for humans and animals. For example, Batal and coworkers determined the minimum bioavailable zinc required for chicks at 1 to 3 weeks of age to be about 22.4 mg of zinc per kg of feed. (2001 Poultry Science 80:87-90). The tests were performed using a zinc deficient soy concentrate diet supplemented with either zinc sulfate heptahydrate or tetrabasic zinc chloride (“TBZC”). The bioavailability of the zinc from TBZC was essentially the same as that from zinc sulfate heptahydrate.

Like other micronutrients, not all zinc-containing compounds are efficient dietary sources of zinc. Results from experiments conducted by Cao and his coworkers (2000 J. Appl. Poultry Res. 9:513-517) showed that only about 49% of the zinc contained in feed-grade zinc oxide was bioavailable to Avian broiler chicks compared to the zinc contained in reagent-grade zinc sulfate heptahydrate. Their tests also showed that basic zinc sulfate and tetrabasic zinc chloride (Zn₅Cl₂(OH)₈) have zinc bioavailability values of 101% and 107%, respectively, relative to the zinc contained in reagent-grade zinc sulfate heptahydrate.

Thus, there is a continuing need to provide micronutrient supplements that are readily bioavailable, storage stable and compatible with a wide variety of different vitamins. The micronutrient supplements should also be cost-efficient to produce and provide a food source for humans and animals that will increase their survivability, growth, health and/or reproductivity.

### SUMMARY

The present disclosure relates to micronutrient food or feed supplements, and the manufacture and use thereof. Various aspects of the disclosure are novel, nonobvious, and provide various advantages. While the actual nature of the disclosure provided herein can only be determined with reference to the claims appended hereto, certain forms and features, which are characteristic of the preferred embodiments disclosed herein, are described briefly as follows.

Thus, there is provided in the present disclosure a micronutrient food or feed supplement comprising an ammine chloride salt provided in a form suitable for consumption by animals and having the formula (NH₄Cl)ₓ.M(NH₃)_{y}Cl_{z} where M represents an essential metal, x is zero or greater, y is greater than zero, and z is at least 2. A variety of essential metals, including, but not limited to Zn, Cu, Mg, Mn, Ca, Fe, Co and Cr are readily absorbed by animals when the metal is formulated as ammine chloride salt. Specific embodiments of the preferred metal ammine chloride salt include, but are not limited to, a zinc diammine chloride micronutrient supplement of the formula Zn(NH₃)₂Cl₂, a copper diammine chloride micronutrient supplement of the formula Cu(NH₃)₂Cl₂, and related double salts such as ammonium amine copper chloride, NH₄Cl.Cu(NH₃)₂Cl₂, otherwise written as (NH₄Cu(NH₃)₂Cl₃)_{0.3333} by crystallographers.

The present disclosure also provides a method of enhancing the growth of humans and other animals by providing a micronutrient comprising at least one ammine salt of an essential metal having the formula (NH₄Cl)ₓ.M(NH₃)_{y}Cl_{z} where M is a cation of the essential metal, x is zero or greater, y is greater than zero and z is at least 2. Preferred essential metals include, but are not limited to Zn, Cu, Mg, Mn, Ca, Fe, Co and Cr. The micronutrient supplement can be administered directly or it can be admixed with vitamins and other micronutrients to provide a supplemental premix that may be administered to humans or animals. Alternatively, the supplemental premix can be combined with a food or animal feed. When the micronutrient supplement is provided to humans or other animals in a physiologically effective amount, their survivability, growth rate, health and/or reproductivity increases.

The present disclosure further provides a method for preparing a copper ammine chloride salt by first selecting a solution containing a copper salt, an ammonium salt and a chloride salt and additionally having a hydrogen ion concentration reflected by the solution's pH. The solutions selected can be acidic or basic. The solution's pH is adjusted by the addition of acid or base to provide a pH value of from about 4.5 to about 6.5 and to form a slurry. The slurry contains a copper ammine chloride salt which can be isolated from the slurry by a variety of conventional means including, but not limited to, filtration or centrifugation.

### BRIEF DESCRIPTION OF THE DRAWINGS

FIG. 1 is a schematic illustrating a method useful to prepare zinc diammine chloride salt for use in the present disclosure.

FIG. 2 is a schematic illustrating a method useful to prepare copper diammine chloride and/or ammonium ammine copper chloride for use in the present disclosure starting from an acidic solution.

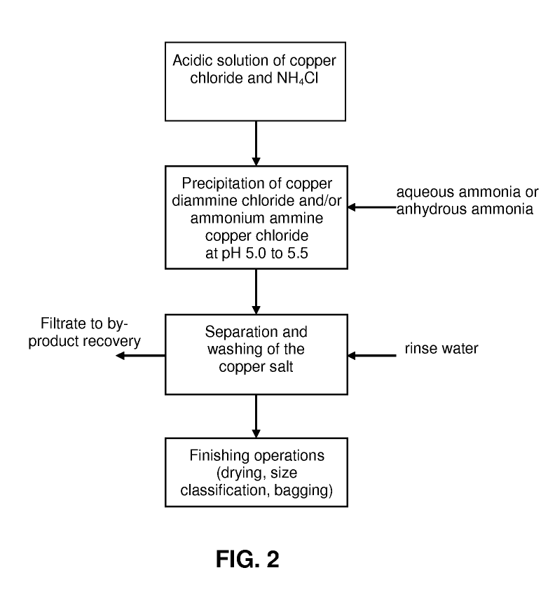

FIG. 3 is a schematic illustrating a method useful to prepare copper diammine chloride and/or ammonium ammine copper chloride for use in the present disclosure starting from a basic solution.

FIG. 4 is a graph illustrating the solubility of copper in mg/liter as a function of pH.

### DESCRIPTION

Generally, this disclosure provides a micronutrient supplement that comprises an ammine chloride that contains a divalent or trivalent cation of an essential metal. The micronutrient supplements according to the current disclosure can be administered directly to humans or animals in a variety of forms including, but not limited to, as a solid, a suspension or an admixture containing other nutrients such as vitamins, minerals, and food or animal feeds. The micronutrients are administered to enhance the survivability, growth, health and/or reproductivity of humans and animals.

The micronutrient supplement of the present disclosure provides good bioavailability of the essential metal in that it is readily absorbed or taken up in a biologically-effective amount. The micronutrient can be combined with other nutrients or vitamins, to provide a premixed supplement.

An essential metal is defined for the purposes of this disclosure as a metal whose uptake by humans or other animals in a biologically effective amount increases their survivability, growth, health and/or reproductivity. The mode of action of the essential metal is not critical for the present disclosure. For example, the essential metal can act as a co-factor or a catalyst in a metalloenzyme or metalloprotein; it can be adsorbed by a variety of tissues. Alternatively, the essential metal or a metabolite thereof can inhibit growth of bacteria or other pathogens detrimental to the survivability, growth, health and/or reproductivity of the animal.

Preferred metal amine chloride salts have the formula (NH₄Cl)ₓ·M(NH₃)_{y}Cl_{z}, where M is a divalent or trivalent metal, x is zero or larger, y is selected to be a real number greater than zero, and z is generally at least 2. The subscripts x, y and z can be selected as non-integers in certain embodiments. Preferred essential metals include, but are not limited to zinc, copper, magnesium, manganese, calcium, iron, cobalt and chromium.

In one embodiment of the present disclosure, the essential metal is a divalent metal cation, M, preferably selected from the group of divalent metal cations that includes zinc, copper, magnesium, manganese, calcium, iron, and cobalt; x is zero or larger, y is selected to be a real number greater that zero; and z is generally at least 2. In certain embodiments, x, y and z can be selected as non-integers.

In an alternative embodiment of the present disclosure, the essential metal is a trivalent metal cation, M, selected from the group of trivalent metal cations that includes chromium, iron and cobalt; x is zero or larger, y is selected to be a real number greater than zero; and z is generally 3 or higher. In certain embodiments, x, y and z can be selected as non-integers.

Within a homologous series of ammine chloride compounds of metal M, the values of x, y and z may be dependent on the experimental conditions used to prepare the salt. For example, x, y or z may be dependent upon the pH at which the salt is prepared. Alternatively, x, y or z may be dependent upon the ammonia, ammonium or chloride concentration in the reaction medium. Accordingly, a variety of ammine chloride salts can be prepared for a homologous series of compounds having the same cationic essential metal. It is understood that varying the values for x, y and z influences the solubility, bioavailability, nutritional value and enhanced vitamin stability of the micronutrient supplement.

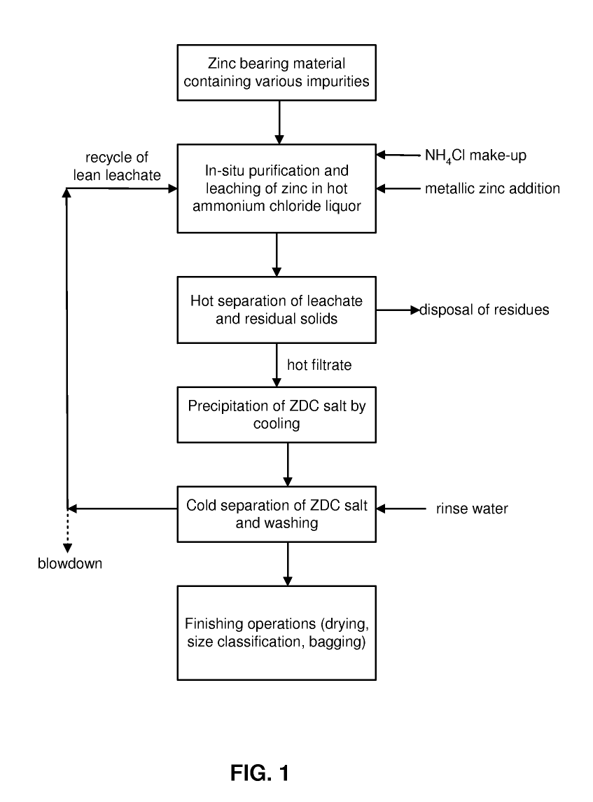

A representative example of a laboratory bench-scale procedure for preparing zinc diammine chloride (“ZDC”) is depicted in FIG. 1 which is useful for small-scale preparation of one of the preferred embodiments of the present disclosure. The method is particularly attractive for making ZDC from impure or waste zinc residuals such as zinc oxide produced by air pollution abatement equipment at brass mills (sometimes referred to as brass mill baghouse dust), or “crude zinc oxide” produced from thermal processing of electric arc furnace dust. Such materials are available as inexpensive waste products because they typically contain significant concentrations of impurities such as lead, cadmium and copper. Moreover, beneficial reuse outlets for such “crude” materials have recently become scarce because of new environmental restrictions imposed by US EPA (Federal Register, 2002).

The first step of the method depicted in FIG. 1 is to leach the zinc from a zinc bearing material using a hot solution of ammonium chloride. A 250-300 g/L solution of ammonium chloride is typically used as the extraction liquor. This is placed in a reactor and the zinc bearing material is then added in an amount needed to satisfy the solubility of ZDC in the hot extraction liquor. Preferred extractions are generally conducted at a pH ranging from about 6 to about 7. The slurry is heated and maintained at a temperature of about 150° F. to about 200° F. for about 1.5 hours at which time the extraction of the zinc is essentially complete. The solubility of zinc in ammonium chloride is relatively high for this temperature range, e.g., about 75 g/L. Although not intended to limit the present disclosure, Equation 1, provided below, is believed to represent the reaction that occurs during the extraction process.

ZnO+2NH₄Cl→Zn(NH₃)₂Cl₂+H₂O Equation 1

### At this point the reactor contains hot pregnant liquor and residual solids.

The hot ammonium chloride extraction method is not selective for zinc. Impurities such as lead, copper and cadmium are also dissolved by the leach solution. When present in the zinc bearing raw material, these impurities are generally displaced from the leach solution by the addition of metallic zinc. This “cementation” technology is an oxidation-reduction reaction where the added metal (e.g., zinc) goes into solution and the dissolved metal (e.g., lead) comes out of solution in metallic form. An example of the cementation reaction is as follows:

PbCl₂+Zn^{o}→Pb^{o}+ZnCl₂ Equation 2

The method shown in FIG. 1 has surprisingly been found to produce relatively clean pregnant liquor containing ZDC, using only two distinct process steps: hot extraction followed by liquid-solids separation. Filtration of the hot extraction liquor and crystallization of ZDC from the resulting filtrate provides ZDC, substantially free from a variety of other metal impurities.

Further background related to the ammonium chloride extraction of zinc can be found in U.S. Pat. Nos. 3,849,121, 5,208,004, 5,810,946, 6,423,281 and 6,517,789. Additional references to the preparation of ZDC can be found in U.S. Pat. Nos. 6,454,828 and 4,865,831.

The CDC and/or AACC salt can similarly be prepared from tribasic copper chloride by a similar pH adjustment as illustrated in Equation 5 and as described in Example IV below.

Cu₂(OH)₃Cl+3NH₄Cl+NH₄OH→2Cu(NH₃)₂Cl₂↓+4H₂O Equation 5

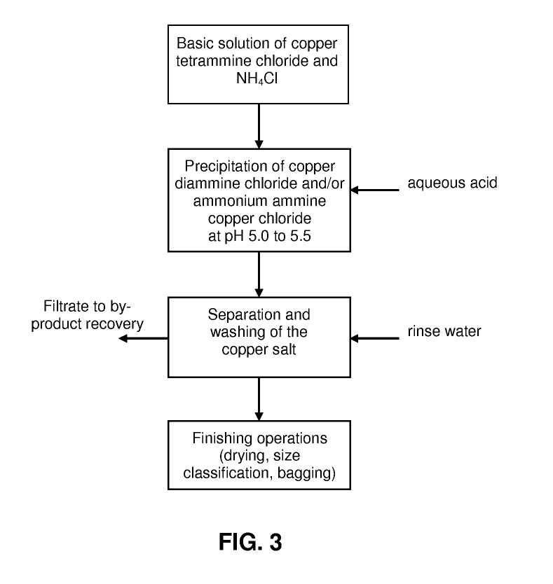

As illustrated in FIG. 3, the copper ammine chlorides can also be prepared from alkaline solutions of a copper salt in the presence of ammonia and a chloride source by adding an acid. A mineral acid such as, for example, hydrochloric acid is preferred. Sufficient acid can be added to provide a pH of from about 4.5 to about 6.5, preferably from about 5.0 to about 6.0, and more preferably from about 5.0 to about 5.5. Preferred processes are carried out at from about 10° C. to about 40° C. Ammonium chloride can provide a source of both ammonia and chloride.

For the purpose of promoting further understanding and appreciation of the present disclosure and its advantages, the following examples are provided. It will be understood, however, that these examples are illustrative and not limiting in any fashion.

### EXAMPLE I

### Preparation of ZDC from Brass Mill Baghouse Dust

The raw material for this example was zinc oxide “baghouse dust” from a brass mill. The dust contained about 34% zinc and the impurities included lead (1.4%), copper (3,400 mg/kg) and cadmium (190 mg/kg). ZDC was made from this material by the in situ purification/hot ammonium chloride zinc extraction procedure described above.

(a) The effectiveness of the in-situ purification/hot extraction method was evaluated by comparing performance at hot vs. cold temperatures. For this experiment, 25 grams of baghouse dust and 8 grams of metallic zinc were added to 200 ml of stock ammonium chloride solution (300 g/L). After mixing for about an hour at room temperature, a sample of the supernatant was collected and filtered.

The reactor was then operated at a temperature of about 175° F. for 1.5 hours, after which a sample of the supernatant was collected and filtered. The analyses of the filtered samples from the two temperature conditions clearly showed that the extraction and cementation reactions are very effective when operated at hot temperatures, but less effective at temperatures approaching room temperatures:

| | | |
|---|---|---|
| Reaction time: | 55 min | 90 min |
| Reaction temperature: | 72° F. | 175° F. |
| Filtered extraction liquor: | | |
| Zinc | 10.5 g/L | 75.6 g/L |
| Lead | 1,270 mg/L | (<1 mg/L) |
| Copper | 460 mg/L | 1 mg/L |
| Cadmium | 210 mg/L | (<1 mg/L) |

(b) Additional tests were conducted to further assess the effectiveness of various methods for producing a clean ZDC product. Three different samples of ZDC salts were analyzed for purity by dissolving them with hydrochloric acid in deionized water. The first sample of ZDC was prepared without the in situ purification feature and was not washed after filtration. The second sample was the same as the first, but had been washed after filtration. The third sample was prepared using the in situ purification technique, but was not washed after filtration. The results summarized in TABLE I showed that a clean ZDC salt could be prepared by the in situ purification technique used alone or in combination with washing the salt after filtration:

TABLE I

| | Zn | Pb | Cu | Cd | B |
|---|---|---|---|---|---|
| ZDC Sample | (mg/L) | (mg/L) | (mg/L) | (mg/L) | (mg/L) |
| No in situ purification, | 6,670 | 486 | 7.5 | 3.1 | 13.1 |
| not washed | | | | | |
| No in situ purification, | 6,630 | 365 | 1.4 | 1.5 | 2.7 |
| washed | | | | | |
| With in situ purification, | 7,110 | 1.2 | 0.0 | 0.7 | 12.6 |
| not washed | | | | | |

### EXAMPLE II

### Preparation of ZDC from Crude Zinc Oxide

The starting material used for this example was crude zinc oxide generated from thermal treatment of electric arc furnace dust. Impurities included lead (1.2%). The extraction liquor used was ammonium chloride brine generated as a byproduct from a manufacturing process for making tribasic copper chloride from spent circuit board etchants. The metallic zinc used for the cementation purification reaction was waste zinc shot material. All of the key components for this example thus came from low-grade byproducts or waste materials.

The concentration of ammonium chloride in the brine was adjusted to about 275 g/L. Crude zinc oxide was added to the brine to produce a zinc loading of about 80 g/L. The slurry was mixed and heated to between 165° F. and 175° F. for at least 30 minutes. While heating, 8 g/L of metallic zinc shot was added to remove metal impurities via the in situ purification method. The hot slurry was then filtered using a pre-heated Buchner funnel. Preheating the filter apparatus enabled the pregnant liquor to remain hot during filtration to keep the ZDC in solution. The hot filtrate was collected in an Erlenmeyer filter flask and then cooled to room temperature. The white ZDC salt precipitated from solution as the pregnant liquor cooled. The cooled slurry was then filtered to harvest the ZDC salt. Near the end of the filtration, a small amount of deionized water was added to rinse dissolved components and soluble impurities off the ZDC salt. The washed ZDC solids were then dried at about 220° F. Finishing operations included crushing and size classification of the ZDC product. The assay of the finished product was 38.8% zinc, as expected for ZDC. Impurities from the raw feed stock were either absent or present in trace amounts.

### EXAMPLE III

### Bioavailability of Zinc Diammine Chloride

An experiment was conducted to compare the bioavailability of zinc from zinc diammine chloride (ZDC or Zn(NH₃)₂Cl₂) with that of reagent grade zinc sulfate heptahydrate (ZSH or ZnSO₄.7H₂O). A zinc-free basal corn-soybean diet was formulated. The zinc sources were added to the basal diet at doses of 4 mg Zn per kg and 8 mg Zn per kg. The basal and experimental diets were mixed using a horizontal mixer for basal diet and a Hobart mixer for individual treatments. All diets were fed as a mash feed. Eighty male avian broiler chicks were used in the 20-day experiment. The test birds were randomly divided into 20 pens of 4 birds each. The birds were housed in thermostatically controlled, stainless steel battery cages with raised wire flooring in an environmentally controlled facility. Environmental conditions for the birds (i.e., floor space, temperature, lighting, feeder and water space) were similar for all test groups. The chicks were pretested for the first three days after hatching; and then they were switched to the basal diet until the start of the study at day eight. Water that had been deionized and distilled and feed was available for ad libitum consumption.

All feed added to the pens was recorded. Feed was weighed back at the conclusion of the trial and the feed intake was calculated. The ratio of weight gain to feed consumed was calculated for the period using the average weight gain of birds per treatment divided by the average feed consumption for the treatment throughout the test period. The results from the experiment are summarized in TABLE 2.

TABLE 2

| | Zn | Feed Intake | Weight Gain | Gain:Feed |
|---|---|---|---|---|
| Treatment | (mg/kg) | (g/chick) | (g/chick) | (g/kg) |
| Basal Diet (control) | 0 | 173.0 | 72.3 | 420 |
| Basal + ZnSO₄•7H₂O | 4 | 201.8 | 100.5 | 497 |
| Basal + Zn(NH₃)Cl₂ | 4 | 189.8 | 99.3 | 523 |
| Basal + ZnSO₄•7H₂O | 8 | 233.5 | 119.8 | 514 |
| Basal + Zn(NH₃)Cl₂ | 8 | 235.3 | 126.5 | 538 |

Compared to the control, the addition of 4 and 8 mg Zn from ZDC per kg feed improved overall weight gain by about 37% and 75%, respectively. The addition of 4 and 8 mg Zn from ZDC also improved the weight gain per unit of feed by about 24% and 28%, respectively. The test results for the ZDC treatments were better than those observed from the lab grade ZSH treatments. Assuming a zinc availability of 100% for reagent-grade zinc sulfate, the relative bioavailability of zinc from zinc diammine chloride was 110%. Thus the overall conclusion from the experiment was that zinc diammine chloride was an excellent source of bioavailable zinc.

### EXAMPLE IV

### Preparation of Ammonium Ammine Copper Chloride Salt from TBCC Mother Liquor

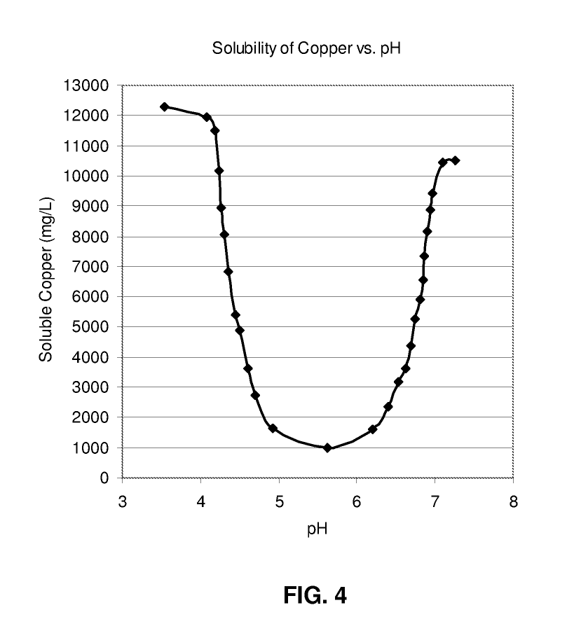

The starting material used for this example was mother liquor remaining after the production of tribasic copper chloride (TBCC) from spent circuit board chemical etchants. The particular sample of mother liquor was slightly acidic, contained several hundred grams per liter of ammonium chloride and about 12 g/L of dissolved copper. The series of tests were conducted at room temperature. A 400 mL sample was titrated with NH₄OH solution having a specific gravity of 0.93 and containing about 16% NH₃ by weight. The pH and soluble copper concentrations were measured after each increment of NH₄OH solution added. The results are illustrated in FIG. 4. Precipitation of copper initiated at a pH of about 4.1 and continued until the pH reached about 5.5. It was apparent that the copper amine chloride salt was forming at least within the pH range of 4.5 to 5.6. As expected from the stoichiometry of Equation 3, about 1 mole of copper was precipitated for every 2 moles of ammonia added. For this particular series of tests, the minimum solubility of copper was about 1,000 mg/L at a pH of about 5.6. As more ammonium hydroxide was added to raise the pH above 5.6, the copper amine chloride salt dissolved to form a navy blue soluble copper tetrammine complex. At a pH above about 7.2 virtually all of the copper ammine chloride salt had dissolved. For the conversion of the copper from insoluble diammine to soluble tetrammine, about 1 mole of copper went back into solution for every 2 moles of ammonia added. This is consistent with the identification of the blue precipitate as the diammine chloride of copper. However, analyses by X-ray diffraction (XRD) have indicated that the blue precipitated solid is ammonium ammine copper chloride, i.e., a double salt comprised of ammonium chloride and copper diammine chloride: NH₄Cl.Cu(NH₃)₂Cl₂. It is conjectured that the blue salt in the mother liquor is indeed copper diammine chloride, but upon filtration and drying to make a finished granular product, the dissolved ammonium chloride crystallizes out of solution to form the double salt.

The titration curve shown in FIG. 4 is reversible in that at alkaline pH's the soluble copper tetrammine can be converted back to the diammine by simple adding an acid to lower the pH. Thus the copper ammine chloride and/or AACC salt(s) can also be prepared from alkaline solutions of ammonium chloride and copper (e.g., from spent ammonical etchant from circuit board manufacturing) by adding hydrochloric or other acids.

The present disclosure contemplates modifications as would occur to those skilled in the art. It is also contemplated that processes embodied in the present disclosure can be altered, rearranged, substituted, deleted, duplicated, combined, or added to other processes as would occur to those skilled in the art without departing from the spirit of the present disclosure. In addition, the various stages, steps, procedures, techniques, phases, and operations within these processes can be altered, rearranged, substituted, deleted, duplicated, or combined as would occur to those skilled in the art. All publications, patents, and patent applications cited in this specification are herein incorporated by reference as if each individual publication, patent, or patent application was specifically and individually indicated to be incorporated by reference and set forth in its entirety herein.

Further, any theory of operation, proof, or finding stated herein is meant to further enhance understanding of the present disclosure and is not intended to make the scope of the present disclosure dependent upon such theory, proof, or finding.

1. A feed supplement comprising a pharmaceutically acceptable ammine chloride salt of at least one essential metal provided in a form suitable for consumption by animals, wherein the ammine salt has the formula (NH₄Cl)ₓ·M(NH₃)_{y}Cl_{z}, wherein M is a cation of the essential metal, x is zero or larger, y is greater than zero, and z is at least 2.

2. The feed supplement of claim 1, wherein M is a divalent cation.

3. The feed supplement of claim 2, wherein the divalent cation is selected from the group consisting of Zn⁺², Cu⁺², Mg⁺², Mn⁺², Ca⁺², Fe⁺², and Co⁺².

4. The feed supplement of claim 3, wherein M is Zn⁺², x is 0, y is 2 and z is 2.

5. The feed supplement of claim 3, wherein M is Cu⁺², x is 0, y is 2 and z is 2.

6. The feed supplement of claim 3, wherein M is Cu⁺², x is 1, y is 2 and z is 2.

7. The feed supplement of claim 1, wherein M is a trivalent cation and z is at least 3.

8. The feed supplement of claim 7, wherein the trivalent cation is selected from the group consisting of Fe⁺³, Cr⁺³, and Co⁺³.

9. A method of enhancing the growth of an animal by providing micronutrient comprising at least one ammine salt of an essential metal having the formula (NH₄Cl)ₓ·M(NH₃)_{y}Cl_{z} wherein M is a cation of the essential metal, x is zero or larger, y is greater than zero, and z is at least 2.

10. The method of claim 9, wherein M is a divalent cation and y is 2.

11. The method of claim 10, wherein the divalent cation is selected from the group consisting of Zn⁺², Cu⁺², Mg⁺², Mn⁺², Ca⁺², Fe⁺², and Co⁺.

12. The method of claim 11, wherein M is Zn⁺², x is 0, y is 2 and z is 2.

13. The method of claim 11, wherein M is Cu⁺², x is 0, y is 2 and z is 2.

14. The method of claim 11, ’wherein M is Cu⁺², x is 1, y is 2 and z is 2.

15. The method of claim 11, wherein M is a trivalent cation and z is at least 3.

16. The method of claim 11 wherein the ammine salt is combined with a pharmaceutically acceptable carrier.

17. The method of claim 11 wherein the ammine salt is admixed with a food product or an animal feed.

18. The method of claim 9, wherein M is a trivalent cation and z is at least 3.

19. The method of claim 18 wherein the trivalent cation is selected from the group consisting of Fe⁺³, Cr⁺³, and Co⁺³.

20. The method of claim 18 wherein the ammine salt is combined with a pharmaceutically acceptable carrier.

21. The method of claim 18 wherein the ammine salt is admixed with a food product or an animal feed.

22. A method for preparing a copper ammine chloride salt comprising:
(a) selecting a solution containing a copper salt, an ammonium salt, a chloride salt, and having a hydrogen ion concentration and a pH derived from said hydrogen ion concentration;
(b) adjusting said pH to a value of from about 4.5 to about 6.5 to form a slurry containing copper ammine chloride salt, and
(c) isolating said copper ammine chloride salt from said slurry.

23. The method of claim 22, wherein said copper ammine chloride salt is a salt selected from the group consisting of ammonium ammine copper chloride (AACC), copper diammine chloride (CDC), and a combination thereof.

24. The method of claim 22, wherein said selecting involves selecting a solution having an acidic pH and said adjusting involves adding a base to said solution.

25. The method of claim 24, wherein said adjusting involves said base being ammonia.

26. The method of claim 25, wherein said adjusting involves said ammonia being an aqueous form of ammonia.

27. The method of claim 25, wherein said adjusting involves said ammonia being an anhydrous form of ammonia.

28. The method of claim 25, wherein said adjusting is carried out at a temperature of from about 10° C. to about 40° C.

29. The method of claim 28, wherein said adjusting involves adjusting said pH to a value from about 5.0 and about 6.0.

30. The method of claim 29, wherein said selecting involves selecting a solution wherein said copper salt is copper chloride and wherein said ammonium salt and said chloride salt are ammonium chloride.

31. The method of claim 29, wherein said selecting involves selecting a solution wherein said copper salt is tribasic copper chloride and wherein said ammonium salt and said chloride salt are ammonium chloride.

32. The method of claim 22, wherein said selecting involves selecting a solution having an alkaline pH and said adjusting involves adding an acid to said solution.

33. The method of claim 32, wherein said adjusting involves adding a mineral acid to said solution.

34. The method of claim 33, wherein said adjusting involves adding hydrochloric acid to said solution.

35. The method of claim 34, wherein said adjusting is carried out at a temperature of from about 10° C. to about 40° C.

36. The method of claim 35, wherein said adjusting involves adjusting said pH to a value of from about 5.0 to about 6.0.

37. The method of claim 24 wherein said selecting involves selecting a solution wherein said copper salt is tribasic copper chloride and wherein said ammonium salt and said chloride salt are ammonium chloride.

38. The method of claim 32, wherein said selecting involves selecting a solution wherein said copper salt is copper tetrammine chloride and wherein said ammonium salt and said chloride salt are ammonium chloride.
